(19) United States
(12) Patent Application Publication
(10) Pub. No.: US 2007/0216136 A1
(43) Pub. Date: Sep. 20, 2007

(54) SINGLE CAMERA APPARATUS AND METHODS FOR ALIGNMENT OF A TRAILER HITCH

(76) Inventor: Dan L. Dietz, Richmond, TX (US)

Correspondence Address: TUMEY, L.L.P., P.O. BOX 22188, HOUSTON, TX, 77227-2188, US

(21) Appl. No.: 11/308,306

(22) Filed: Mar. 15, 2006

(51) Int. Cl. B60D 1/36

(52) U.S. Cl. 280/477

(57) ABSTRACT

A system for facilitating the backing of a vehicle to couple a hitch and trailer, the system including a camera and a mirror for allowing capture of visual images of both the approaching vehicle and the trailer tongue, to assist in backing the vehicle and making the coupling.

### BACKGROUND OF THE INVENTION

1. Field of the Invention

The present invention relates to hitches. In another aspect, the present invention relates to hitches, and to methods, apparatus and products for engagement of hitches with trailers and the like. In even another aspect, the present invention relates to hitches, and to single camera methods, apparatus and products for engagement of hitches with trailers and the like

2. Brief Description of the Related Art

For many years now vehicles that are temporarily connected to trailers have been used to transport boats, off-road vehicles, lawn maintenance equipment, and other vehicles. Generally, a hitch assembly connected to the towing vehicle and trailer is employed to permit their interconnection.

Standard trailer hitches commonly include a socket on the tongue of a trailer for connection with a ball mounted on the towing bar of the towing vehicle. Coupling of the ball and socket requires the driver of the motor vehicle to rearwardly maneuver the vehicle until the ball of the hitch is vertically aligned with the socket of the trailer. Without assistance, the driver typically has difficulty maneuvering the ball into position for engagement with the socket since the ball and socket are outside the driver's field of vision. Even with assistance, vertical alignment of the trailer hitch components may be a frustrating and time consuming task. Additionally, damage to the vehicle or trailer is a real possibility with such blind maneuvering.

For even experienced drivers, hookup requires much trial and error. Generally, the driver must back up slowly and repeatedly stop the vehicle and exit the vehicle to determine the new location of the hitch with respect to the trailer hitch so as to not damage the vehicle. This is undesirable for user's who utilize trailers often such as farmers. Hence, there is a need for a trailer hitch alignment system that allows a user to conveniently align a vehicle with a trailer hitch without the user having to exit the vehicle.

As would be expected, many devices have been put forth to solve this problem, dating back a number of years and extending to the present. Most such devices include a pair of co-operating visual aids, one secured to the trailer and the other secured to the towing vehicle, so that alignment of the hitch components may be made by maneuvering the vehicle from the driver's seat. Representative of these are U.S. Pat. Nos. 3,918,746, 4,285,138 and 4,065,147. Most of these devices are either impractical, easily damaged, or prohibitively expensive. Some hitching assemblies have complicated pivoting components and mechanical guiding members permitting less precise positioning of the vehicle by the operator. (U.S. Pat. Nos. 2,197,157 and 2,844,390)

Other devices recognize the shortcomings of all of the line of sight devices, and provide for “blind” coupling, depending upon electronic sensors, signal transmitters and the like.

Many of these devices, however, are electromechanical, in that some physical connection between the towed and the towing vehicle is necessary. U.S. Pat. No. 4,030,775 utilizes a spool of wire with a micro-switch connected to a display to show how much of the wire is extended or retracted, which indicates relative coupling positions of the hitch components. Similarly, U.S. Pat. No. 4,432,563 utilizes a wire, with the added provision for indication of the direction of deviation of the wire from axial alignment as the towing vehicle maneuvers. Other patents utilizing a combination of electronics, display, and switching devices include U.S. Pat. No. 2,797,406 (hitch contact switches carried by towing vehicle), U.S. Pat. No. 3,418,628 (position switches tripped by ball) and U.S. Pat. No. 4,187,494 (flexure of a member utilized as a sensing means for indication of relative angular and linear positions). U.S. Pat. No. 3,825,921 utilizes a wave emitter on the towing vehicle and a wave receiver coil on the trailer. A current is induced in the coil, which is monitored to show relative positions of the emitter and receiver coils. The physical connection between the towing and the towed vehicles is in this case an electrical conductor. However, a considerable number of components and electrical controls are necessary.

In contrast, U.S. Pat. No. 3,924,257 issued Dec. 2, 1975, to Roberts, employs no mechanical connection between the trailer and towing vehicle. The '257 patent discloses a trailer hitch guidance system for assisting the operator of a towing vehicle, during the backing of the later, provides a transmitter on the vehicle to be towed and a receiver on the towing vehicle which receives a signal from the transmitter and detects from the amplitude and the polarity of the respective coordinate signals generated thereby, the direction and proximity of the towing vehicle with respect to the towed vehicle.

U.S. Pat. No. 4,192,526, issued Mar. 11, 1980, to Myers, discloses a hitch guide assembly comprising a target post vertically positioned above a socket member of a towed vehicle and sighting means vertically positioned above a ball member of a towing vehicle. The sighting means comprises a V-shaped mounting bracket which magnetically couples to the towing vehicle and has an extension arm pivotally attached to the mounting bracket. The sighting means further includes a guide pointer which may be selectively positioned along the extension arm so that, when combined with the pivoted adjustment of extension arm, the outer end portion of the guide pointer is substantially positioned over the coupling member of the towing vehicle.

U.S. Pat. No. 4,285,138, issued Aug. 25, 1981, to Berry, discloses aligning devices for aligning a towing vehicle with a trailer wherein the towing vehicle has a ball and the trailer vehicle a socket carrying arm. A pair of magnetic bases having vertically positionable wands are placed one on the towing vehicle and one on the trailer. Each wand has an elastic gromet slidable along its length for retaining a signal flag on its upper side and to permit passage between the wand and the gromet of a plumb line. There are two plumb lines and two plumb bobs which when the lines are vertical and the two plumb bobs positioned immediately above the ball and the trailer socket, the alignment flags will be horizontal so that when the vehicle is backed toward the trailer unit the flags cross then hookup can be effectuated.

U.S. Pat. No. 4,723,788, issued Feb. 9, 1988, to Suter, discloses an apparatus for facilitating the alignment of a trailer hitch socket with the ball mounted on the towing vehicle is provided wherein a couple of interfitting masts are used. The first mast mounts atop the socket on the trailer tongue and extends vertically upward high enough to the point which it is visible from the towing vehicle. The second mast has a collar to engage it on the ball of the trailer hitch attached to the towing vehicle. It also extends upwardly to a height at which it is visible from within the towing vehicle. As the vehicle backs up toward the trailer, the driver can see the two masts and steer such that they will come closer and closer together and finally nest together when the socket is directly over the ball.

U.S. Pat. No. 4,905,376, issued Mar. 6, 1990, to Neeley, discloses a hitch viewing mirror assembly detachably mounts directly to the tow vehicle, either a special tail-gate clamping means for a pick-up truck or a magnetic mount for a passenger car, thus the tow view operator may view the two vehicle hitch member and the trailer hitch member while operating the tow vehicle during the coupling process thereby providing a particularly effective method of aligning the position of the hitch members.

U.S. Pat. No. 4,988,116, issued Jan. 29, 1991, to Evertson, discloses a trailer hitch positioning aid having a magnetic switching unit mounted upon the hitch ball and a corresponding permanent magnetic field unit secured to the socket of the hitch. The magnetic switches are mounted about the ball in a triangular pattern, while the magnetic field is in a “U” shape, so that closing of one or more of the magnetic switches indicates relative position of the hitch ball and socket. No physical connection is necessary between the trailer and the towing vehicle.

U.S. Pat. No. 5,035,441, issued Jul. 30, 1991, to Murray, discloses a visual aid to assist a driver in maneuvering a towing vehicle toward a trailer or other vehicle to be towed for precisely aligning the hitch components of the two vehicles. The device mounts only to the towed vehicle and includes an integral bumper member to protect the vehicles should the driver back too far. The device is adaptable to all conventional trailer hitch components and is simple and easy to use. It comprises a universal adaptor, a sighting mast and a strap for attaching the assembly to the towed vehicle. The mast can be mounted in the vertical position for viewing through the back window or at an angle to extend laterally past the side of the tow vehicle to allow the driver to view the mast even if rearward visibility is blocked through the rear window of a tow vehicle. The mast is disturbed from its rest position when the hitch components are aligned. The device is also designed such that it can be mounted to a vehicle to provide an early warning signal to the driver of closely approaching an object.

U.S. Pat. No. 5,108,123, issued Apr. 28, 1992, to Rubenzik, discloses a vehicle docking device includes a matrix of sensors arranged in a planar array of rows and columns spaced apart from one another. The matrix of sensors is mounted proximate the hitch ball of the towing vehicle in a horizontal plane. An activator is supported in a predetermined position relative to the towing hitch of the vehicle to be towed for activating one of the sensors closest thereto. The activator is positioned to be directed at the center point of the sensor matrix when the hitch ball is directly under the towing hitch. The sensor matrix is electrically coupled to a corresponding array of indicators disposed near the driver of the towing vehicle. Each indicator is associated with a corresponding sensor. By observing the array of indicators, the driver can determine whether the hitch ball and towing hitch are aligned, or in what direction correction is required.

U.S. Pat. No. 5,113,588, issued May 19, 1992, to Walston, discloses a trailer hitch alignment guide device, for a ball and socket hitch, wherein the guides can be mounted either to the rear or side, wherein the sighting elements on the guides are visually emblematic of the coupling elements, where one sighting element is isomorphic of the hitch ball and the other sighting element is isomorphic of the socket, and where the sighting elements are scribed with lines which visually amplify deviations from alignment.

U.S. Pat. No. 5,269,554, issued Dec. 14, 1993, to Law et al., discloses an alignment guide includes a plurality of guide assemblies, one of which is mounted to a trailer hitch ball and the other mounted to a trailer tongue, wherein the guides each include telescoping vertical leg members for alignment and communication relative to one another for the positioning of a trailer hitch tongue relative to an associated trailer ball.

U.S. Pat. No. 5,558,352, issued Sep. 24, 1996 to Mills, discloses a trailer hitch alignment device which allows the driver of a vehicle to align the hitch of the driven vehicle with that of its trailer with no aid from another individual. The invention utilizes two masts having acrylic flags attached thereto mounted upon the hitch components of the respective vehicles to provide visual reference points for the driver. The acrylic flags are bright in color which allow them to be sufficiently illuminated by the reverse lights of the towing vehicle during times of darkness, thereby making night-time hitch alignment possible. Each mast is mounted to a hitch component via a dome-shaped base having several magnets underneath. The magnets provide the attraction force necessary to mount the masts to the hitch components and the shape of the mounting bases provide the bases with the ability to mounted upon virtually any hitch configuration. The mountings are further secured through the use of velcro-type straps which extend from the mounting bases to the hitch components. This enhances stability and, therefore, performance, of the invention when alignment is required over rough terrain or high winds. The invention further has a swing arm offset bracket to allow for the mounting of the masts on towing vehicles having spare tires mounted on their rear.

U.S. Pat. No. 5,650,764, issued Jul. 22, 1997, to McCullough, discloses a visual aid for assisting a driver backing up a towing vehicle to a drawn vehicle. A visual display includes a flat screen upon which are depicted images in the form of silhouettes or like simulations of the respective vehicles. This effect is provided by partially and selectively illuminating the screen. A sensor is placed on at least one of the vehicles for detecting relative alignment therebetween and proximity thereof. The sensor generates a signal which controls the screen. The silhouettes are moved on the screen in proportion to the actual relationship of the two vehicles. In a preferred embodiment, the image of the towing vehicle is stationary, and the image of the drawn vehicle moves responsive to input from the sensor. The sensor may employ an emitting coil and an induction coil, or may be of the reflected energy type, such as radar and infrared radiation. The display control preferably comprises a microprocessor. The visual aid has an on-off switch, a proximity readout, and an alarm annunciating the presence of an object interposed between the tow vehicle and the draft vehicle.

U.S. Pat. No. 5,669,621, issued Sep. 23, 1997, to Lockwood, discloses a device for facilitating the alignment of a trailer hitch socket with the ball mounted on the towing vehicle is composed of a fixed sight member, a pivoting sight member, and a stop plate. The pivoting sight member mounts on the edges of the trailer tongue and extends vertically upward to the point which it is visible from the towing vehicle. The fixed sight member is magnetically attached to the towing vehicle and mounted adjacent the towing ball on the trailer hitch. The fixed sight member extends vertically upward to a height at which it is visible from within the towing vehicle. As the vehicle backs up toward the trailer, the driver can see the two sight members and steer such that they will come closer and closer together. When the socket is directly over the ball the pivoting sight member is actuated and signals the driver that alignment is achieved. The stop brace prevents the towing vehicle from colliding with the trailer hitch.

U.S. Pat. No. 5,680,706, issued Oct. 28, 1997, to Talcott, discloses a device for alignment of a trailer and a towing vehicle which consists of a visible mast placed on the trailer tongue to allow the towing vehicle driver to view the mast and to easily back into a correct position for coupling with the trailer. The mast has a pivotable arm which can be secured in either an extended contact position or a relaxed, downward position as necessary.

U.S. Pat. No. 5,729,194, issued Mar. 17, 1988, to Spears et al., discloses various configurations of components to provide for either informing an operator of a vehicle of relative positions of the vehicle and a stationary trailer during a backing procedure or informing the operator of an arrival at a hitchable position during the backing procedure. Three general embodiments are disclosed which include use of a magnetically activated switch, use of an autofocus assembly and use of a light reflective arrangement. Several possible combinations of the separate embodiments are explained which enhance the function of the assemblies to ensure proper positioning of the vehicle relative to the stationary trailer. Explanations of each embodiment are provided along with numerous variations to each. Each of the embodiments relies upon a component, or group of components, located on the vehicle which require a power source to operate. When it is a requirement that a component be placed upon the stationary trailer, that component does not require a source of power. An explanation of various modes of informing the operator of the feedback from the deployed components are presented. These include both audio feedback as well as visual feedback.

U.S. Pat. No. 5,821,852, issued Oct. 13, 1988, to Fairchild, discloses an apparatus for indicating axial alignment or deviation from alignment, and proximity between a tow vehicle and a trailer towards which the tow vehicle must be maneuvered. The apparatus comprises a storage reel mounted on the tow vehicle for storing and paying out a cord, a pulley having a magnet for mounting the pulley temporarily on the trailer hitch, and a take up reel mounted on the tow vehicle for applying tension to the cord. As the tow vehicle is maneuvered, changes in relative position between tow vehicle and trailer cause the cord to change length and angular orientation relative to the tow vehicle. These changes are sensed as one or both of the storage reel and take up reel rotate responsive to cord changes. A plurality of switches make or break contact to a matrix of indicating lamps located in the cabin of the tow vehicle, the indicating lamps indicating position of the tow vehicle relative to the trailer. The reels are permanently or temporarily mounted on the tow vehicle. The pulley has a magnet for temporary, readily removable attachment to the trailer hitch.

U.S. Pat. No. 5,861,814, issued Jan. 19, 1999, to Clayton, discloses a new trailer hitch with sensor system for allowing for easier alignment for coupling with a trailer. The inventive device includes a hitch portion secured to a rear portion of a towing vehicle. The hitch portion has an upper ball portion. The upper ball portion has a pair of sensors disposed therein. Each of the sensors are connected to a central wire. The central wire extends interiorly of the vehicle. A trailer tongue extends outwardly from a trailer. The trailer tongue has a ball socket formed within a free end thereof. The ball socket is dimensioned for receiving the upper ball portion of the hitch portion therein. The ball socket has a magnet disposed therein for being sensed by the sensors of the upper ball portion. A display box is positioned interiorly of the vehicle. The display box is in communication with the central wire of the pair of sensors. The display box provides signals related to a proximity of the trailer tongue to the hitch portion.

U.S. Pat. No. 5,951,035, issued Sep. 14, 1999, discloses a trailer hitch alignment system which includes an alerting device and a tow bar assembly for attachment to a towing vehicle. The tow bar assembly includes a photoelectric sensor for detecting the vertical alignment of a trailer tongue. The tow bar assembly has a hitch ball with a spherical top and a cylindrical body for coupling with a trailer tongue having a semi-spherical socket. In one embodiment, the photoelectric sensor is mounted on the tow bar of the tow bar assembly, adjacent to the hitch ball. In another embodiment, the hitch ball houses the photoelectric sensor within its interior. During operation, the driver of the towing vehicle typically maneuvers the vehicle toward the trailer in a rearward direction. Once the photoelectric sensor detects the vertical alignment of the socket with the ball, the alerting device is activated informing the driver of the alignment.

U.S. Pat. No. 6,100,795, issued Aug. 8, 2000, to Otterbacher et al., discloses a trailer hitch alignment system for allowing a user to easily align a hitch of a vehicle with a trailer hitch. The inventive device includes a control that is mountable to a visor of the vehicle in view of the driver, a receiver unit attachable to the bumper of the vehicle and in communication with the control unit, a transmitter unit removeably attachable to a trailer hitch that transmits a locating signal that is detectable by the receiver unit, and a storage case. Electronic circuitry within the control unit determines the position of the transmitter unit from the receiver unit from the reception of the locating signal. The control unit includes a turn right indicator and a turn left indicator for visually indicating to the user whether to turn left or right while backing toward the conventional trailer. The control unit also includes a buzzer and stop indicator light for indicating to the user when the ball hitch is positioned below the coupler of the trailer hitch. The control unit also includes a display screen that visually indicates the position of the vehicle with respect to the trailer hitch. If the user needs to turn left or right, either the turn left indicator or the turn right indicator will display various levels of lights indicating to the user that they must turn appropriately for proper alignment of the vehicle with the conventional trailer.

U.S. Pat. No. 6,222,457, issued Apr. 24, 2001, to Mills et al., discloses a trailer hitching system and method is provided for facilitating an operator's maneuvering of a towing vehicle hitch component into alignment with a towed vehicle hitch component to enable mechanical interconnection of the hitch components. The trailer hitching system includes an alignment sensor attached to either the towing vehicle or the towed vehicle for emitting a light beam over a field of view. A reflector attached to the other of the towing vehicle or the towed vehicle is mounted at a predetermined location relative to the alignment sensor. The reflector reflects a portion of the light beam emitted from the alignment sensor. An alarm in the alignment sensor emits an audible alarm in response to detecting a portion of the reflected light beam. The activation of the audible alarm indicates that the reflector is within the field of view of the alignment sensor and thereby the hitch components are moving towards alignment.

U.S. Pat. No. 6,341,794, issued Jan. 29, 2002, to Hunter, discloses a trailer hitch alignment apparatus comprising a first guide member removably attached to a vehicle bumper and a second guide member removably attached to a trailer hitch socket. The first guide member includes a magnetic base with a telescopically extensible rod adjustably coupled thereto. The second guide member includes a magnetic base having an upwardly extending telescopic rod and a downwardly extending semi-flexible shaft attached thereto. The shaft extends downwardly through a bore defined by the trailer hitch tongue so as to contact the trailer hitch ball when the ball and socket are aligned. Contact between the shaft and ball causes vertical displacement of the shaft and guide rod. Therefore, the two telescopic guide rods, visible from a driver's seat, facilitates lateral alignment of the ball and socket while vertical displacement of the second rod indicates perfect forward alignment.

U.S. Pat. No. 6,612,603, issued Sep. 2, 2003, to Alger, discloses a trailer hitch alignment hitch system uses height adjustable stanchions with length adjustable arms terminating in mirrors. The stanchions are respectively connectible to a tow vehicle and a trailer and placed so that the mirror is aligned vertically over the hitch connection component of the tow vehicle and the trailer and adjusted so that the respective mirrors are at different heights. The tow vehicle operator backs the tow vehicle until the mirrors visually indicate vertical alignment by one mirror coming into place below the other mirror and obstructing the view of the hitch component.

U.S. Pat. No. 6,517,098, issued Feb. 11, 2003, to Grasso et al., discloses an alignment device to align a vehicle's trailer hitch ball neck assembly with a trailer hitch socket assembly or tongue assembly. The invention includes two units, each having uprights with engaging press on members. The ball neck upright member has a “C”-shaped bottom portion for frictionally engaging the neck of the trailer hitch ball neck, and the hitch engaging upright member has a “U”-shaped bottom portion for frictionally engaging the outer housing of the hitch socket member around its lower end periphery. When used in conjunction with each other, the two poles visually assist the vehicle operator in aligning the vehicles so that they may be easily coupled together for towing.

U.S. Pat. No. 6,454,290, issued Sep. 24, 2002, to Turner, discloses a trailer hitch alignment device has a base block for placement on the coupler of a trailer. The block has a magnet at its bottom for being connected to the coupler and a series of apertures directed at varying angles to receive an upright post inclined at a selected angle. A cross arm extending generally horizontally is connected to the post in a manner such as to allow adjustments in vertical and horizontal directions. The post-to-cross arm connection has pair of block members through which the post and cross arm pass and a spring biasing the members together.

U.S. Pat. No. 6,712,378, issued Mar. 30, 2004, to Austin, discloses a trailer hitch alignment device is provided having a hitch alignment guide and a ball target mast. The hitch alignment guide has a vertically disposed, elongated alignment mast affixed to a magnetic, disc shaped hitch base. The ball target mast is composed of a vertically disposed, elongated alignment mast affixed to a magnetic, ring shaped ball base. The masts are telescoping shafts having linearly spaced alignment indicia are provided in a linearly spaced manner along the upper portion of the shafts.

U.S. Pat. No. 6,765,607, issued Jul. 20, 2004, to Mizusawa et al., discloses a driving aiding system for displaying a picked-up image of a rear-view camera equipped onto a rear portion of a vehicle on a screen of a displaying means arranged at a position which can be viewed from a driver's seat when the vehicle is to be backed, a locus estimated line of a hitch which is equipped onto a rear portion of the vehicle is superposed on the picked-up image of the rear-view camera to display when a predetermined instruction input is received.

U.S. Pat. No. 6,827,363, issued Dec. 7, 2004, to Amerson, discloses an alignment apparatus for assisting a driver in directing coupling engagement between a towing vehicle hitch and a trailer hitch. The apparatus includes a guide carried by the towing vehicle representing the position of the towing vehicle hitch for being visible to the driver. A target is carried by the trailer representing the position of the trailer hitch for being visible to the driver. The target has a pair of laterally spaced posts defining a target zone for receiving the guide to align the towing vehicle hitch with the trailer hitch for coupling engagement. A sensor is carried by the guide for determining whether the guide is within the target zone. An indicator is operatively associated with the sensor for indicating to the driver when the guide is within the target zone to alert the driver of alignment between the towing vehicle hitch and the trailer hitch for coupling engagement.

In spite of the many advancements in the art of trailer hitches and the coupling of such hitches with a trailer, there exists a need in the art for improved apparatus, methods and products for coupling a hitch and trailer.

This and other needs in the art will become apparent to one of skill in the art upon review of this specification, including its drawings and claims.

### SUMMARY OF THE INVENTION

It is an object of the present invention to provide for improved apparatus, methods and products for coupling a hitch and trailer.

This and other objects of the present invention will become apparent to one of skill in the art upon review of this specification, including its drawings and claims.

According to one embodiment of the present invention, there is provided a camera system comprising a storage and mounting container, a mounting member affixed to the container, a camera boom positioned within the box and adapted to slide in and out of the box, a camera affixed on the boom; and a monitor removably positioned within the box, wherein during operation of the system the camera and monitor are in communication.

According to another embodiment of the present invention, there is provided a camera system comprising: a camera with a lens defining a field of view, and a mirror positioned in a portion of the field of view, wherein said portion is less than the entire field of view.

According to even another embodiment of the present invention, there is provided a camera system comprising: a camera boom, a camera affixed to the boom, and a magnetic mounting member, wherein the boom is swivelably mounted to the mounting member and swivelably positionable between a first position and a second position.

According to other embodiments of the present invention, there are provided methods of operating the above camera systems. For example, methods of backing a vehicle or hitching a trailer to a vehicle using the above camera systems.

These and other embodiments of the present invention will become apparent to one of skill in the art upon review of this specification, including its drawings and claims.

### BRIEF DESCRIPTION OF THE DRAWINGS

FIG. 1 is an illustration of backing apparatus 100 mounted on trailer tongue 205.

FIG. 2 is an isometric view of backing apparatus 100 of FIG. 1, showing camera 110 and reflective surface 118.

FIG. 3 is a side view of backing apparatus 100 of FIG. 1, showing camera 110 and reflective surface 118.

FIG. 4 is an illustration showing the near approach of vehicle 215 and trailer tongue 205, with camera system 100 mounted thereon.

FIGS. 5 and 6 are illustrations of display screen 410 showing approaching vehicle 215 and trailer tongue 205.

FIG. 7 is a view of vehicle 215 and trailer 218, with camera system 100 mounted on vehicle 215 transmitting a view of trailer hitch 203 to monitor 410 inside of vehicle 215.

FIG. 8 is a side view, and FIG. 9 is a top view of the embodiment of camera system 100 of FIG. 7, showing, mounting bracket 101 having a magnetic coupler 103 to hold camera system 100 to vehicle 215, and swing arm 129 having light 114 controlled by switch 115, and camera 100.

FIG. 10 is an illustration of an embodiment of the present invention show in box 400 which serves not only to store the camera system, but also as a mounting system.

In the drawings, it should be understood that like references numbers refer to like elements.

### DETAILED DESCRIPTION OF THE INVENTION

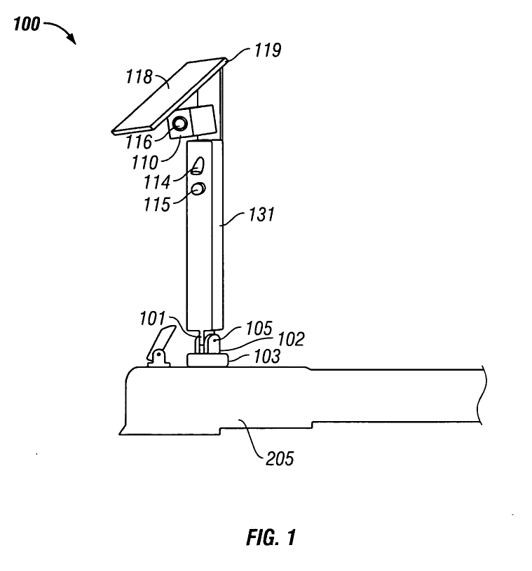

The present invention is most easily described by reference to the drawings. Referring first to FIG. 1, there is shown an illustration of backing apparatus 100 mounted on trailer tongue 205.

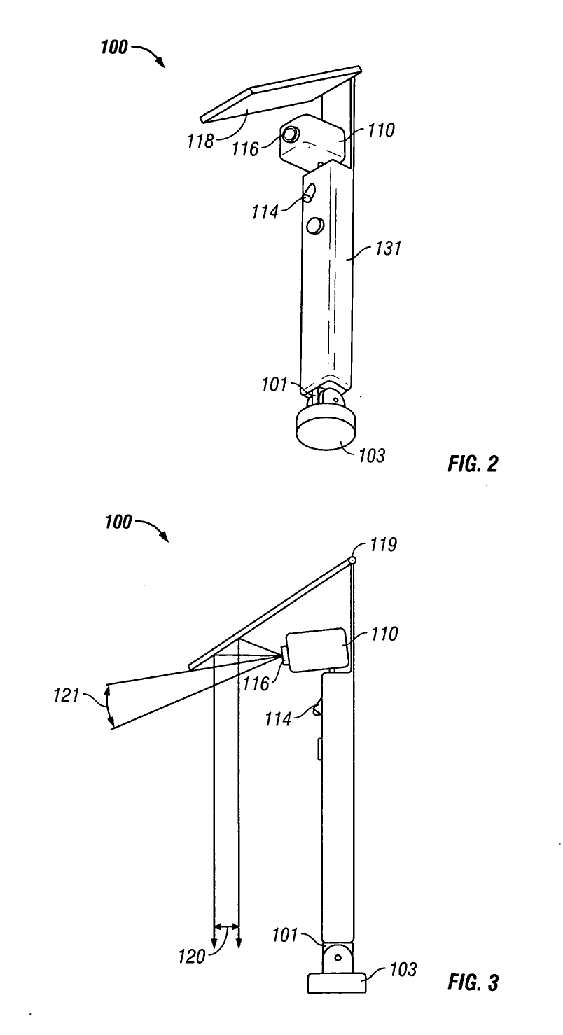

Additional details of backing apparatus 100 are provided in FIGS. 2 and 3, which provide isometric and side views, respectively, of backing apparatus 100 of FIG. 1, showing camera 110 and reflective surface 118.

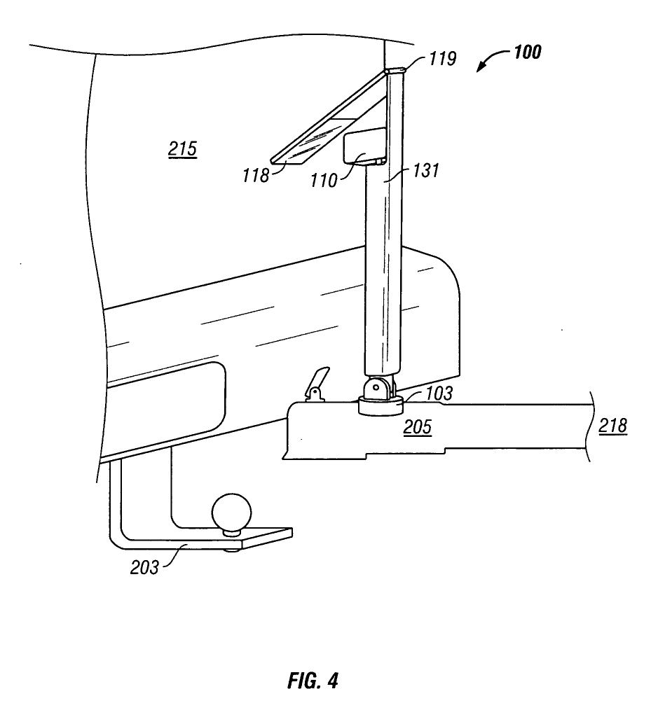

FIG. 4 shows a near approach of vehicle 215 and trailer tongue 205, with camera system 100 mounted thereon.

Backing apparatus will include at least a camera 110 and a reflective surface 118 for splitting the camera lens 116 field of view into a reflected field of view portion 120 and a non-reflected field of view portion 121. Images captured using this system will appear to be in split screen format once viewed. This system allows for the capture of images in multiple locations without the need for multiple cameras. While reflective surface 118 is shown as being external to lens 116, it is believed that it can alternatively be incorporated into and part of lens 116. As even another embodiment, lens 116 may include two or more lens which may have different fields of view.

While backing apparatus is show as capturing a non-reflected field of view and a reflected field of view, it should be understood that additional reflective surfaces may be provided to capture more than one reflected field of view.

Of course, assuming that camera 110 mounted on the trailer, it should be evident that this allows for simultaneous image capture of the approaching vehicle 215, and of a trailer tongue 205 and its immediate vicinity to observe the approach of hitch 203 to tongue 205.

Alternatively, should camera 110 be mounted on the vehicle, this allows for simultaneous image capture of the approaching trailer 218, and of a hitch 203 and its immediate vicinity to observe the approach of hitch 203 to tongue 205.

Reflective surface 118 may be adjustably mounted to housing 131 to allow reflective surface 118 to be aimed as desired. In the embodiment as shown, hinge 119 allows reflective surface 118 to be pivoted to allow for adjustment in the relative size of reflected field of view 120 and non-reflected field of view 122.

In the embodiment as shown, camera system 100 further includes a support housing 131 in which are positioned one or more batteries, although it should be understood that batteries could be positioned immediately within camera 110, or that camera system 100 could be powered off of the vehicle electrical system. This support housing 131 also allows for camera 110 to be mounted a distance above trailer tongue 205.

Support housing 131 is also provided with a mounting bracket 101 may mounted to trailer tongue 205 utilizing any suitable means. Support bracket 101 may be relatively permanently mounted to tongue 205, non-limiting examples of which include use of bonding materials, adhesives, screws, bolts, brackets, fasteners, or may be removeably mounted to tongue 205, non-limiting examples of which include friction fit fasteners, quick release brackets, bracket docking systems, hook and loop fastener systems (for example, those sold under the brandname VELCRO), or as preferred and shown herein by magnetic coupler 103. It is also possible to manufacture vehicle 215 to make backing apparatus 100 integral to the vehicle.

Locking pin 105 pivotally couples mounting bracket 101 with magnetic coupler brackets 102. Backing system 100 may be adjustably pivoted to allow for aiming of the system as desired. While backing system 100 is shown as pivotally mounted, it should be understood that any suitable type of mounting device and method may be utilized, a non-limiting alternative includes a ball and socket joint to allow swivel of backing system 100.

The beauty of using a quick release mounting system such as magnet coupler 103, is that it allows for quick installation of backing system 100 in anticipation of backing, and then for quick removal (and subsequent storage) of backing system 100 upon completion of the backing operation.

As shown in the figures, camera 110 is mounted to provide a view of vehicle 215 and trailer tongue 205 (or alternatively, mounted to provide a view of the trailer and hitch 203). Referring additionally to FIG. 6, there is shown an illustration of display screen 410 for camera 110, showing the backward view of trailer 218 and trailer tongue 205. This view will assist in backing vehicle 215 toward trailer 218 until tongue 205 comes into view of camera 111.

Camera 110 is any suitable type of camera or image capture system, which will generally provide a video of the backing operation, which generally means obtaining a series of images in rapid succession of the backing operation, that is, moving graphical imagery of the backing operation. Camera 110 must not only be able to capture the image of the approaching vehicle on the order of tens of feet away, it must also be able to provide a clear picture of the hitch 203 and trailer tongue 205 from a very short distance, for example, on the order of a few feet or less, perhaps even less then a foot. Camera 110 may also be equipped with a wide angle or fisheye lens. While some success was achieved using a 55 degree lens, better results were achieved with a 140 degree lens. A preferred range is wide angle lens in the range of about 70 to about 140 degrees.

While the term “video” generally refers to moving graphical imagery recorded electronically as opposed “movies” which are recorded on film, as used herein, “video” refers to captured moving graphical imagery regardless of how recorded, transmitted, saved or stored.

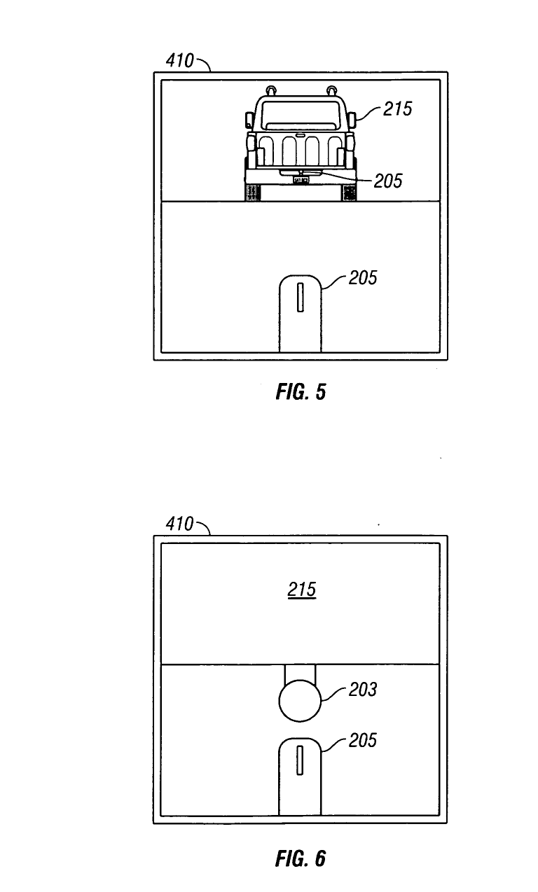

Camera 110 is in communication with a display screen 410, as shown in FIGS. 5 and 6, positioned to be easily viewed by the operator of vehicle 215. This communication may be by a direct or wireless connection. Preferably camera 110 is in wireless communication with display screen 410.

As opposed to the prior art systems which are designed for daytime use, the present invention finds utility during both day and night. This is accomplished by providing infrared lighting and cameras which receive infrared light. Provision is also made to provide a visible light to allow for manual operation of the trailer hitch.

Backing system 100 may include lights mounted to provide light to the backing operation, for example, supported by bracket 101, mounted to vehicle 215, or positioned apart from bracket 101 and vehicle 215. In the embodiment as shown, light 114 is mounted on housing controlled by light switch 115. The lights may be a visible light source, or an infrared light source, or any other suitable light source. A preferred visible light source includes a super white LED light. Preferably, the light source is an infrared light source or a visible light source. Most preferably the light source comprises both infrared light and visible light. Of course, camera 110 is suitable for the light source utilized and may provided with appropriate filters as necessary.

As shown in the figures, camera 110 provides a simultaneous view of approaching vehicle 215 and an overhead downward look at tongue 205. Referring additionally to FIGS. 5 and 6, there is shown an illustration of display screen 410 for camera 110, showing a split screen view of the non-reflected view of approaching vehicle 215 and the reflected downward view of trailer tongue 205. It is this downward view that will allow for very precise maneuvering of trailer 218 to couple or nearly trailer hitch 203 and trailer tongue 205.

Generally during backing, the driver will maneuver the vehicle to keep the trailer tongue at or near the center of display screen 410. Display screen 410 may also comprise aiming indicia to provide guidance during backing. This indicia may be provided directly on the surface of the screen, or may be provided as part of the displayed image.

To avoid distortion of the view, camera 110 is generally positioned such that the center of its field of view is generally perpendicular to tongue travel line 511. As used herein, generally perpendicular does not limit the present invention to 90 degrees, but rather includes a range around 90 degrees that will still allow for adequate viewing of the approach of hitch 203 to trailer tongue 205 without too much distortion as to cause problems for the driver in understanding the dimensions. While not wishing to limit that range to any particular number, non-limiting examples of ranges generally includes 90 degrees plus or minus 40 degrees, preferably includes 90 degrees plus or minus 30 degrees, more preferably includes 90 degrees plus or minus 20 degrees, even more preferably includes 90 degrees plus or minus 10 degrees, yet more preferably includes 90 degrees plus or minus 5 degrees. Thus, the present invention will include any positioning of camera 111 such that the centerline 519 will still allow for adequate viewing of the approach, including having the centerline 519 within the above ranges.

Camera 110 is generally positioned to provide a view from trailer 218 of vehicle 215 (or alternatively from vehicle 215 of trailer 218. While it is possible for its field of view 121 to include a view of hitch 203, preferably, camera 110 is positioned such that its field of view is above and excludes a view of hitch 203. In a preferred positioning, camera 110 is positioned such that as the leading portion of hitch 205 leaves camera 110 field of view 121, it enters or shortly thereafter enters camera 110 field of view 120.

In the first portion of the backing operation, reliance by the driver is from upon camera 110 field of view 121 which is utilized to provide a view to allow maneuvering of vehicle 215 generally toward trailer 218, with the idea to position tongue 205 somewhat in the center of the rear of vehicle 215 and thus near trailer hitch 203. At some point, which is the second portion of the backing operation, hitch 203 is within the field of view 120, at which point, reliance by the driver is upon field of view 120 which is utilized to provide a very close view to allow close quarters maneuvering of hitch 203 close to or into coupling with trailer tongue 205.

At night, light 114 may be used to assist in backing, and once the driver maneuvers vehicle 215 close enough to trailer 218, the driver will exit vehicle 215 and go to the rear of vehicle 215 to secure trailer hitch 203 and trailer tongue 205, hook up safety chains, and perhaps even make electrical connections between vehicle 215 and trailer 218. In the dark, this might require a flashlight or other light source. The present invention anticipates operation of any visible lights 114 to provide light for this securing operation.

Very easily, camera 110 may be mounted on vehicle 215 as desired, or even to trailer 218, or even to an object to be avoided (i.e., a post, building, obstruction, or another vehicle), or to a suitable vantage point to provide assistance, or in any other manner which would facilitate backing or coupling of a trailer/hitch.

While the present invention has been illustrated by mounting apparatus 100 on trailer 218, it also finds utility mounting the backing apparatus on vehicle 215.

In an alternative embodiment of providing backing system 100 with infrared light sources and the ability to receive/transmit infrared images, in a security embodiment of the present invention, camera system 100 may be positioned in a manner to provide daytime or night time security observation of a vehicle, trailer or any other object. As non-limiting examples, the system 100 may be positioned inside parked vehicle 215 to observe areas exterior to vehicle 215, including trailer 218, or may be positioned on vehicle 215 or on trailer 218 to observe, and transmit images to the monitor system, perhaps being observed by a driver while in a restaurant. If equipped with a motion activated alarm system, a warning signal may be provided to the remote monitor. This motion activated alarm system may also be in communication with and activate the vehicle's alarms system, and may also be in communication with and activate a vehicle engine kill switch to prevent starting of the engine.

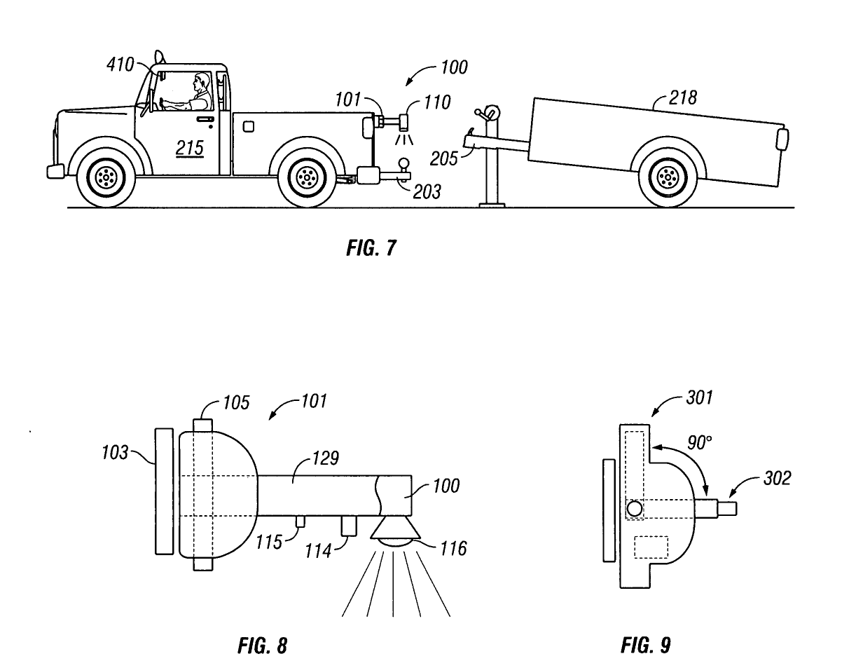

Referring now to FIGS. 7, 8, and 9, there is shown another embodiment of camera system 100 of the present invention.

Specifically, FIG. 7 is a view of vehicle 215 and trailer 218, with camera system 100 mounted on vehicle 215 transmitting a view of trailer hitch 203 to monitor 410 inside of vehicle 215. During backing of vehicle 215, trailer tongue 205 will come into view of camera system 100 to provide guidance in hitching trailer hitch 203 and trailer tongue 205.

FIG. 8 is a side view, and FIG. 9 is a top view of the embodiment of camera system 100 of FIG. 7. As shown, mounting bracket 101 includes magnetic coupler 103 to hold camera system 100 to vehicle 215. Swing arm 129 includes light 114 controlled by switch 115, and camera 100. Lens 116 is pointed down toward hitch 203. Swing arm 129 is pivotally mounted with pivot pin 115 allowing swing arm 129 to be moved between storage position 301 flush against vehicle 215, and backing position 302 when swing arm is perpendicular to its storage position and positions camera 100 above trailer hitch 203. Mechanism maybe provided to bias or lock swing arm 129 in position 301 or 302.

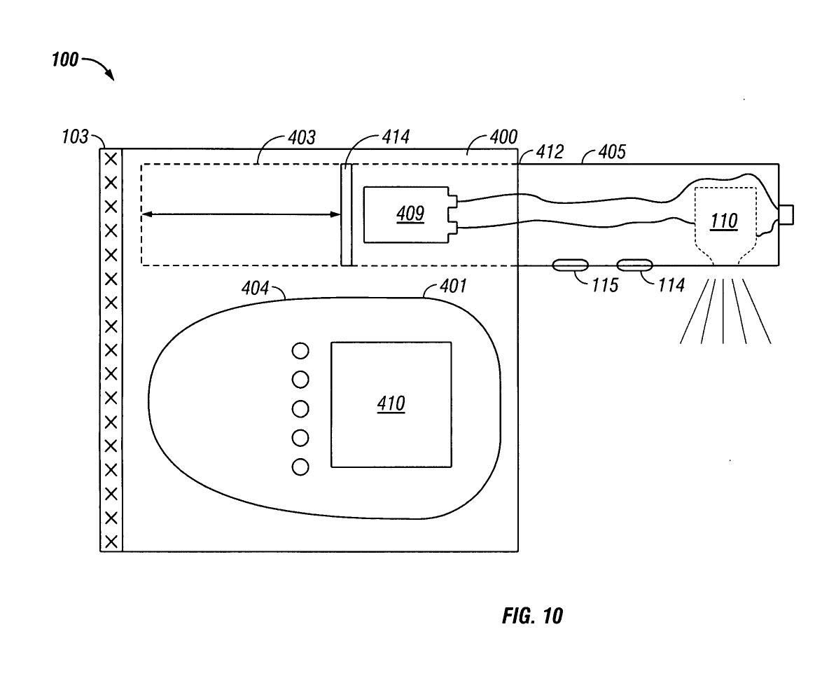

Referring now to FIG. 10, there is shown an embodiment of the camera system 100 of the present invention shown in container 400 which serves not only to store the camera system, but also as a mounting system.

This embodiment of camera system 100 includes a container 400 having a boom slot 403. A boom 405 is slideable within boom slot 403, and is slidable into and out of container 400 thru opening 412 in the side of container 400 to allow positioning of camera 110 as desired. Boom 405 may be fully removeable from boom slot 403 to allow for operation independent of container 400.

In order to maintain the positioning of camera 110, boom 405 may be biased against sliding by employment of spring bias mechanism, friction fit, or any other type of bias against sliding. In the embodiment as shown, boom magnet 414 is magnetically engageable with boom slot 403 to allow for positioning of boom 405. Of course, one of boom 405 and boom slot 403 will be magnetic, with the other being magnetic or ferrous metal. Boom 405 may be of any suitable shape, and preferably tubular with a circular cross-section to allow for rotation of boom 405 within boom slot 403 to permit aiming of camera 110 as desired.

A light 114, operated by switch 115 may be provided. One or more batteries 409 provides power for camera 110 and light 114.

Container 400 also includes a recess 404 for storage of camera monitor 401. Recess 404 is shaped to receive camera monitor 401 and allow it to be removable from recess 404.

Container 400 may optionally include a top/lid that may be hinged to container 400, or which will snuggly fit container 400. Container 400 may include a carrying handle or strap to allow for ease of transportation.

A coupler 103 to allow mounting of container 400 to a structure is also provided. While this coupler may be any suitable type of coupler, or a first half of a coupler system, it is preferable a magnetic coupler to allow for magnetic coupling to ferrous metal or another magnet. Optionally, this magnetic coupler 103 may be moveably positioned on the outside of container 400 to allow for different mounting orientations.

In a trailer hitching operation, container 400 is magnetically affixed to the rear of the vehicle and boom 405 slideably operated to position camera 110 over the hitch (boom 405 may be partially or fully removed from container 400). Monitor 401 is removed from container 400 and positioned to be viewed by the vehicle driver during backing. During backing, camera 110 is in communication with and provides video to monitor 401 to allow alignment of the trailer tongue with the vehicle hitch.

While the present invention has been illustrated mainly by reference to the backing of a vehicle to couple a hitch and trailer, it should be understood that it finds utility for backing a vehicle into a space, a non-limiting example of which includes backing into a parking space, dock, or a narrow confined space, or to avoid, clear, or pass an object.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains. Additionally, it should be understood that not all of the inventions described herein have been incorporated into the claims as originally filed, and that claims may be later added directed to other inventions described herein.

All patents and publications cited herein are hereby incorporated by reference for all that they teach and suggest.

What is claimed is:

1. A camera system comprising:
A storage and mounting container;
A mounting member affixed to the container;
A camera boom positioned within the box and adapted to slide in and out of the box;
A camera affixed to the boom; and
A monitor removably positioned within the box;
Wherein during operation of the system the camera and monitor are in communication.

2. The camera system of claim 1, wherein the boom is biased against movement.

3. The camera system of claim 1, wherein the boom is magnetically biased against movement.

4. The camera system of claim 1, wherein the boom is rotationally movable.

5. The camera system of claim 1, the mounting member is movably affixed to the container.

6. The camera system of claim 1, further comprising a light.

7. The camera system of claim 1, wherein the boom is magnetically biased against movement, and wherein the boom is rotationally movable.

8. A system for backing a vehicle having a trailer hitch to a trailer, the sytem comprising:
A storage and mounting container;
A mounting member affixed to the container and adapted for mounting the container to the vehicle;
A camera boom positioned within the box and adapted to slide in and out of the box;
A camera affixed to the boom, wherein the boom may be operated to position the camera in a position to view the trailer hitch during backing; and
A monitor removably positioned within the box and adapted to be viewed by an operator of the vehicle during backing; and
Wherein during backing the camera and monitor are in communication.

9. The camera system of claim 1, wherein the boom is biased against movement.

10. The camera system of claim 1, wherein the boom is magnetically biased against movement.

11. The camera system of claim 1, wherein the boom is rotationally movable.

12. The camera system of claim 1, the mounting member is movably affixed to the container.

13. The camera system of claim 1, further comprising a light.

14. The camera system of claim 1, wherein the boom is magnetically biased against movement, and wherein the boom is rotationally movable.

15. A method of backing a vehicle using a camera system comprising a storage boom positioned within the box and adapted to slide in and out of the container; a camera affixed to the boom; and a monitor removably positioned within the box, the method comprising:
mounting the container to the vehicle using the mounting member;
operating the boom to position the camera as desired;
removing the monitor from the container and positioning it as desired; and,
operating the camera system during vehicle backing to capture images with the camera and transmit the images to the monitor.

16. A camera system comprising:
A camera boom;
A camera affixed to the boom; and
A magnetic mounting member;
Wherein the boom is swivelably mounted to the mounting member and swivelably positionable between a first position and a second position.

17. The camera system of claim 8, wherein the first position and the second position are 90 degrees apart.

18. A camera system comprising:
A camera with a lens defining a field of view;
A mirror positioned in a portion of the field of view, wherein said portion is less than the entire field of view.
